(19) United States
(12) Patent Application Publication
(10) Pub. No.: US 2014/0377072 A1
(43) Pub. Date: Dec. 25, 2014

(54) ROOT STIFFENER FOR A WIND TURBINE ROTOR BLADE

(71) Applicant: General Electric Company, Schenectady, NY (US)

(72) Inventors: Bradley Graham Moore, Greenville, SC (US); Bharat Bagepalli, Niskayuna, NY (US); Jonathan Henry Zalar, Greer, SC (US); Darren John Danielsen, Glenville, NY (US); Afroz Akhtar, Bangalore (IN); Max Robert Fason, Greer, SC (US); Sujan Kumar Pal, Belonia (IN); Gitesh Verma, Bangalore (IN)

(21) Appl. No.: 13/924,896

(22) Filed: Jun. 24, 2013

(51) Int. Cl. F03D 1/06

(52) U.S. Cl. CPC F03D 1/0633
USPC 416/204 A

(57) ABSTRACT

In one aspect, a rotor blade for a wind turbine includes a body extending between a root end and a tip end. The body may include a root portion extending from the root end. The root portion may include an inner surface defining an inner circumference. In addition, the rotor blade may include a root stiffener disposed at least partially within the root portion of the body. The root stiffener may include a plurality of arms extending radially from the inner surface and may be configured to extend circumferentially around only a portion of the inner circumference of the root portion.

### FIELD OF THE INVENTION

The present subject matter relates generally to wind turbines and, more particularly, to a root stiffener for stiffening the root portion of a wind turbine rotor blade.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy from wind using known airfoil principles and transmit the kinetic energy through rotational energy to turn a shaft coupling the rotor blades to a gearbox, or if a gearbox is not used, directly to the generator. The generator then converts the mechanical energy to electrical energy that may be deployed to a utility grid.

To ensure that wind power remains a viable energy source, efforts have been made to increase energy outputs by modifying the size and capacity of wind turbines. One such modification has been to increase the length of the rotor blades. However, as is generally understood, the loading on a rotor blade is a function of blade length, along with wind speed and turbine operating states. Thus, longer rotor blades may be subject to increased loading, particularly when a wind turbine is operating in high-speed wind conditions.

During the operation of a wind turbine, the loads acting on a rotor blade are transmitted through the blade and into the blade root or root portion of the blade. Thus, as rotor blades are lengthened and the loads acting on such blades increase, there is an increased likelihood that the resulting loads may cause ovalization or out-of-roundness of the root portion. Such ovalization of the root portion may result in an increase in the magnitude of the loads that are transmitted through the root portion and into the pitch bearing and hub of the wind turbine, which may, in turn, increase the likelihood of damage occurring to the hub and/or various other components of the wind turbine (e.g., the main rotor shaft of the wind turbine turbine).

Accordingly, a root stiffener that may be used to reduce the occurrence and/or amount of ovalization within the root portion of a rotor blade would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a rotor blade for a wind turbine. The rotor blade may include a body extending between a root end and a tip end. The body may include a root portion extending from the root end. The root portion may include an inner surface defining an inner circumference. In addition, the rotor blade may include a root stiffener disposed at least partially within the root portion of the body. The root stiffener may include a plurality of arms extending radially from the inner surface and may be configured to extend circumferentially around only a portion of the inner circumference of the root portion.

In another aspect, the present subject matter is directed to a rotor blade for a wind turbine. The rotor blade may include a body extending between a root end and a tip end. The body may include a root portion extending from the root end. The root portion may include an inner surface. In addition, the rotor blade may include a root stiffener at least partially disposed within the root portion of the body. The root stiffener may include a separate arm hub and a plurality of arms coupled to the arm hub. Each arm may extend radially outwardly from the arm hub towards the inner surface of the root portion.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine;

FIG. 2 illustrates a perspective view of one embodiment of one of the rotor blades of the wind turbine shown in FIG. 1;

FIG. 3 illustrates a perspective, exploded view of one embodiment of a root stiffener in accordance with aspects of the present subject matter;

FIG. 4 illustrates a top, assembled view of the root stiffener shown in FIG. 3 installed within a root portion of the rotor blade shown in FIG. 2;

FIG. 5 illustrates a partial, cross-sectional view of the root stiffener shown in FIG. 4 taken about line 5-5;

FIG. 6 illustrates a perspective view of an alternative configuration for the stiffening arms of the root stiffener shown in FIG. 3, particularly illustrating a stiffening arm including a connection flange that projects outwardly along either side of the stiffening arm;

FIG. 7 illustrates a top, assembled view of another embodiment of the root stiffener shown in FIG. 4, particularly illustrating the root stiffener including stiffening arms that flare outwardly in the direction of the root portion of the rotor blade;

FIG. 8 illustrates a top, assembled view of yet another embodiment of the root stiffener shown in FIG. 4, particularly illustrating the root stiffener including a ring-shaped connection flange and a ring shaped connection member;

FIG. 9 illustrates a perspective, partially exploded view of one embodiment of a rotor blade including multiple root stiffeners configured to be installed within its root portion in accordance with aspects of the present subject matter;

FIG. 10 illustrates a top, assembled view of another embodiment of a root stiffener installed within a root portion of the rotor blade shown in FIG. 2 in accordance with aspects of the present subject matter;

FIG. 11 illustrates a top, assembled view of another embodiment of the root stiffener shown in FIG. 10;

FIG. 12 illustrates a top, assembled view of yet another embodiment of the root stiffener shown in FIG. 10;

FIG. 13 illustrates a top, assembled view of a further embodiment of a root stiffener installed within a root portion of the rotor blade shown in FIG. 2 in accordance with aspects of the present subject matter;

FIG. 14 illustrates a partial, cross-sectional view of the root stiffener shown in FIG. 13 taken about line 14-14;

FIG. 15 illustrates a top, assembled view of another embodiment of the root stiffener shown n FIG. 13;

FIG. 16 illustrates a top, assembled view of a further embodiment of a root stiffener installed within a root portion of the rotor blade shown in FIG. 2 in accordance with aspects of the present subject matter;

FIG. 17 illustrates a partial, cross-sectional view of the root stiffener shown in FIG. 16 taken about line 17-17;

FIG. 18 illustrates a partial, cross-sectional view of another embodiment of the root stiffener shown in FIG. 17;

FIG. 19 illustrates a partial cross-sectional view of one embodiment of the root stiffener shown in FIG. 5 having a connection flange(s) coupled to each stiffener arm; and

FIG. 20 illustrates a partial cross-sectional view of another embodiment of the root stiffener shown in FIG. 5 having a connection flange(s) coupled to each stiffener arm.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a root stiffener for a wind turbine rotor blade. Specifically, in several embodiments, the root stiffener may be configured to be installed within the blade root or root portion of a rotor blade in order to increase the stiffness of the root portion, thereby preventing and/or reducing the amount of ovalization occurring within the root portion. As such, the amount of loads transmitted through the root portion and into the pitch bearing and/or hub of the wind turbine may be reduced significantly. Such a reduction in transmitted loads may allow for longer rotor blades to be installed on a wind turbine, which may, in turn, increase the energy capturing capability of the wind turbine.

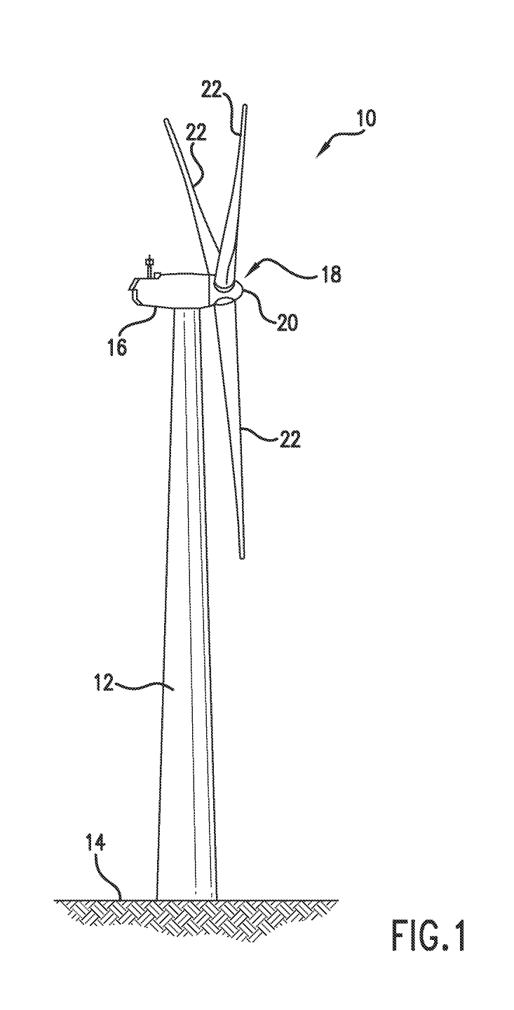

Referring now to the drawings, FIG. 1 illustrates a perspective view of one embodiment of a wind turbine 10. As shown, the wind turbine 10 generally includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator (not shown) positioned within the nacelle 16 to permit electrical energy to be produced.

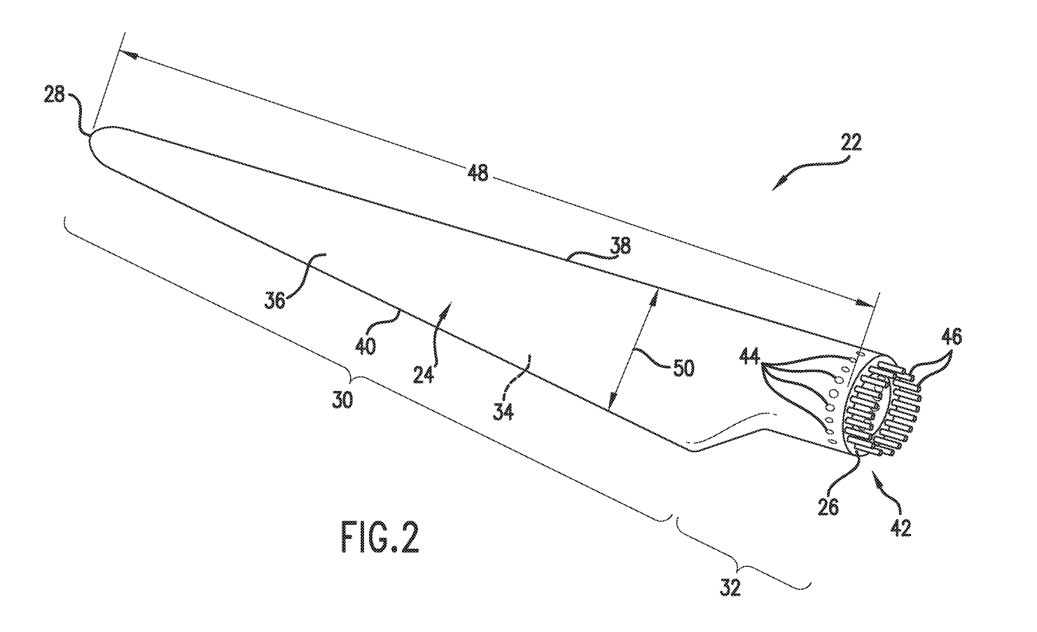

Referring now to FIG. 2, a perspective view of one of the rotor blades 22 shown FIG. 1 is illustrated in accordance with aspects of the present subject matter. As shown, the rotor blade 22 includes a body 24 extending longitudinally between a root end 26 and a tip end 28. The body 24 may generally serve as the outer shell/skin of the rotor blade 22 and may include both an airfoil portion 30 and a root portion 32. As is generally understood, the airfoil portion 30 may extend between the root portion 32 and the tip end 28 of the rotor blade 22 and may generally define an aerodynamic profile (e.g., by defining an airfoil shaped cross-section, such as a symmetrical or cambered airfoil-shaped cross-section) to enable the rotor blade 22 to capture kinetic energy from the wind using known aerodynamic principles. Thus, the airfoil portion 30 may generally include a pressure side 34 and a suction side 36 extending between a leading edge 38 and a trailing edge 40.

Additionally, the root portion 32 may generally be configured to extend between the root end 26 and the airfoil portion 30 of the rotor blade 22. As shown in FIG. 2, at least a portion of the root portion 32 may be configured to define a substantially cylindrical shape. As is generally understood, the root portion 32 may be configured to be mounted or otherwise attached to the wind turbine hub 20 at the root end 26 of the rotor blade 22. Thus, as shown in FIG. 2, the root portion 32 may include a plurality of T-bolts or root attachment assemblies 42 installed therein for coupling the rotor blade 22 to the hub 20. In several embodiments, each root attachment assembly 42 may include a barrel nut 44 mounted within the root portion 32 and a root bolt 46 coupled to and extending from the barrel nut 44 so as to project outwardly from the root end 26. By projecting outwardly from the root end 26, the root bolts 46 may be used to couple the rotor blade 22 to the hub 20 (e.g., via a pitch bearing (not shown)),

Moreover, as shown in FIG. 2, the rotor blade 22 may have a span 48 defining the total length of the blade 22 between its root and tip ends 26, 28 and a chord 50 defining the total length of the blade 22 between the leading edge 38 and the trailing edge 40. As is generally understood, the chord 50 may vary in length with respect to the span 48 as the rotor blade 22 extends from the root end 26 to the tip end 28.

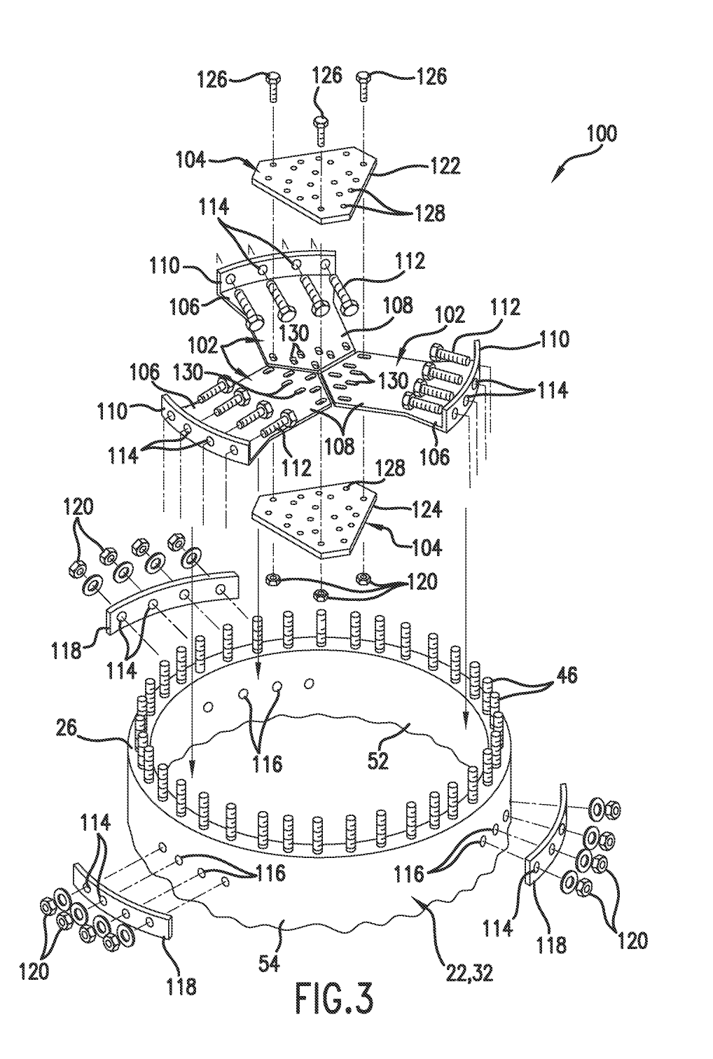

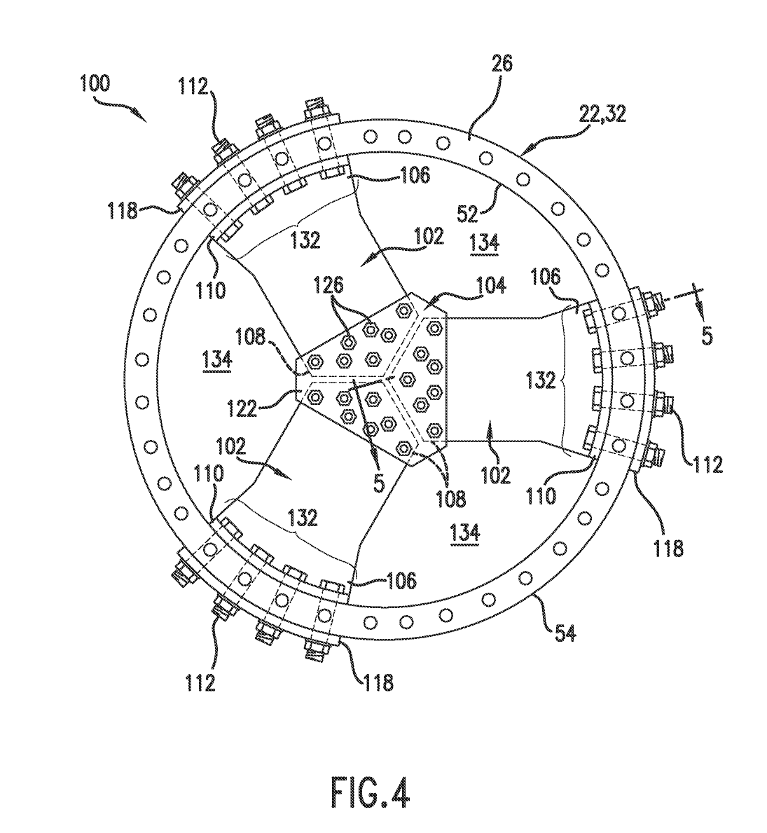

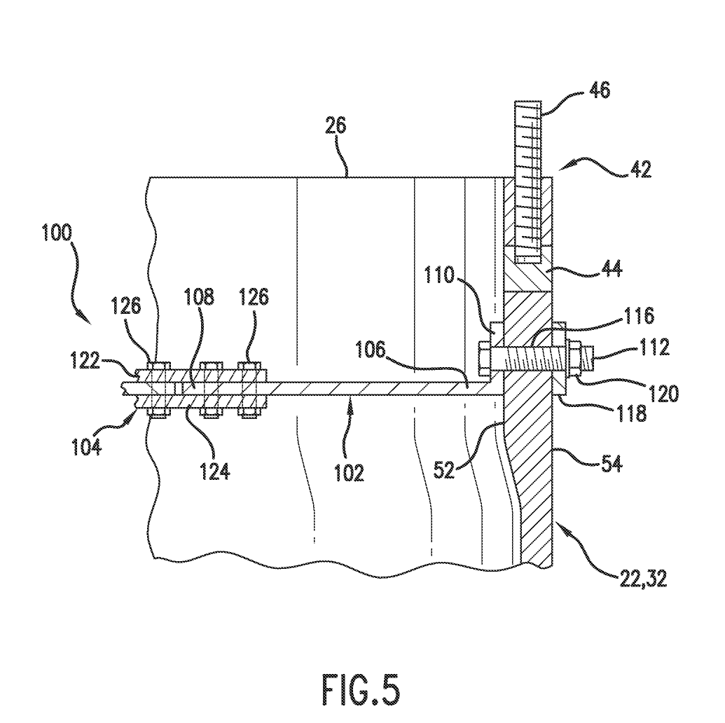

Referring now to FIGS. 3-5, one embodiment of a root stiffener 100 suitable for use with the rotor blade 22 described above is illustrated in accordance with aspects of the present subject matter. In particular, FIG. 3 illustrates a perspective, exploded view of the root stiffener 100. FIG. 4 illustrates a top, assembled view of the root stiffener 100 shown in FIG. 3 installed within the root portion 32 of the rotor blade 22. Additionally, FIG. 5 illustrates a partial, cross-sectional view of the root stiffener 100 shown in FIG. 4 taken about line 5-5.

In general, the root stiffener 100 may be configured to be installed within the root portion 32 of the rotor blade 22. Specifically, in several embodiments, the root stiffener 100 may be configured to extend within and/or across the interior of the root portion 32 so that the root stiffener 100 contacts an inner surface 52 of the root portion 32 at various locations around its inner circumference. As such, when installed within the rotor blade 22, the root stiffener 100 may generally increase the overall stiffness and/or rigidity of the root portion 32, thereby preventing and/or reducing the amount of ovalization within the root portion 32.

In several embodiments, the root stiffener 100 may include a plurality of stiffening arms 102 configured to be coupled between the root portion 32 and a separate arm hub 104. Specifically, as shown in the illustrated embodiment, each stiffening arm 102 may extend radially between a first end 106 and a second end 108, with the first end 106 being configured to be coupled to the root portion 32 and the second end 108 being configured to be coupled to the arm hub 104,

It should be appreciated that, by configuring the root stiffener 100 to include a plurality of separate components (i.e., a plurality of separate stiffening arms 102 configured to be separately coupled to an arm hub 104), the root stiffener 100 may be quickly and easily installed within the rotor blade 22 up-tower. For example, the stiffening arms 102 and arm hub 104 may be separately positioned within the rotor blade 22, thereby avoiding any installation issues that may be associated with maneuvering a large, one-piece stiffener past existing wind turbine components located within and/or adjacent to the root portion 32.

In several embodiments, a connection flange 110 may be formed or otherwise disposed at the first end 106 of each stiffening arm 102 for coupling the arm 102 to the root portion 32. For example, as shown in the illustrated embodiment, each connection flange 110 may be configured as an arced or curved segment configured to extend or project outwardly from the first end 106 of each stiffening arm 104 (e.g., by extending perpendicularly from the first end 106). As such, when the stiffening arms 102 are installed within the root portion 32, each connection flange 110 may generally be configured to extend along and/or adjacent to the inner surface 52 of the root portion 32. Thereafter, one or more suitable fasteners 112 (e.g., bolts, screws, threaded rods, etc.) may be inserted through each connection flange 110 to allow the stiffening arms 102 to be coupled to the root portion 32. For example, as shown in FIG. 3, each connection flange 110 may define one or more connection openings 114 configured to be aligned with corresponding root openings 116 (FIGS. 3 and 5) defined in the root portion 32. Thus, by aligning the connection opening(s) 114 with the corresponding root openings 116, the stiffening arms 102 may be coupled to the root portion 32 via the fasteners 112.

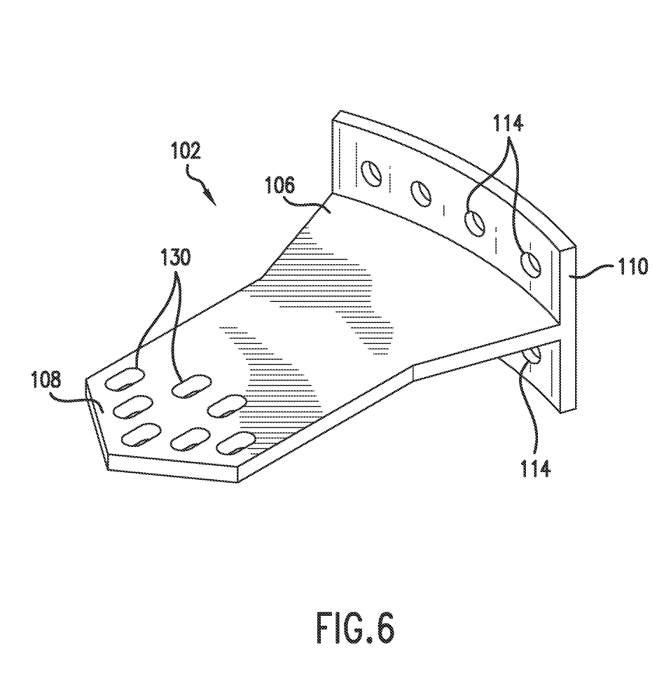

It should be appreciated that the connection flanges 110 may generally have any suitable configuration that facilitates coupling the stiffening arms 102 to the root portion 32. However, it has been recognized by the inventors of the present subject matter that a significant stress concentration may be present at the interface defined between each stiffening arm 102 and the root portion 32. Thus, it may be desirable for the connection flanges 110 to be configured to extend outwardly from the first end 106 of each stiffening arm 102 so as to contact the inner surface 52 of the root portion 32 along one or both sides of the stiffening arms 102, thereby providing additional structural support at the arm/root portion interface. For example, as shown in FIGS. 3-5, each connection flange 110 is configured as an “L” flange (i.e., by configuring each flange 110 to extend outwardly from the first end 106 of each stiffening arm 102 in one direction). In another embodiment, as shown in the perspective view of FIG. 6, each connection flange 110 may be configured as a “T” flange (i.e., by configuring each flange 110 to extend outwardly from the first end 106 of each arm 102 in both directions). In such an embodiment, it should be appreciated that the connection openings 114 may be defined on both sides of each connection flange 110 (as shown in FIG. 6) or only along one side of each connection flange 110. In further embodiments, the connection flanges 110 may have any other suitable flange configuration.

It should also be appreciated that each connection flange 110 may be formed integrally with its corresponding stiffening arm 102 or the connection flanges 110 may be separately attached to the stiffening arms 102. For example, in several embodiments, the connection flanges 110 may be configured to be separately welded to the stiffening arms 102 or separately attached to the stiffening arms 102 using any other suitable means (e.g., suitable fasteners, such as brackets, pins, bolts, screws, threaded rods, etc.). In addition, in one embodiment, the connection flanges 110 may be formed from a separate material than the stiffening arms 102.

Additionally, it should be appreciated that, in embodiments in which the fasteners 112 are configured extend entirely through the root portion 32, the root stiffener 100 may also include a plurality of outer connection members 118 disposed along an outer surface 54 of the root portion 32 to allow the fasteners 112 to be tightened without damaging the rotor blade 22. For example, as shown in FIG. 3, each connection member 118 may comprise an arced or curved segment configured to extend along and/or adjacent to the outer surface 54 of the root portion 32. Additionally, similar to the connection flanges 110, each connection member 118 may define one or more connection openings 114 configured to receive the fasteners 112. Thus, as shown in the illustrated embodiment, the fasteners 112 may be inserted through the aligned openings 114, 116 defined in the connection flanges 110, the root portion 32 and the connection members 118 and subsequently secured therein using nuts 120 (and, optionally, washers) and/or any other suitable components.

As indicated above, the second end 108 of each stiffening arm 102 may be configured to be coupled to the arm hub 104 of the root stiffener 100. In general, the arm hub 104 may include any suitable components and/or may have any suitable configuration that allows the stiffening arms 102 to be coupled to and extend radially outwardly from the arm hub 102 towards the inner surface 52 of the root portion 32. For example, in several embodiments, the arm hub 104 may comprise one or more hub plates 122, 124. Specifically, as shown in FIGS. 3 and 5, the arm hub 104 includes a first hub plate 122 and a second hub plate 124, with the hub plates 122, 124 being configured to extend adjacent to opposed sides of the second end 108 of each stiffening arm 102 so as to form a double-lap joint connection between the arm hub 104 and the each stiffening arm 102. In another embodiment, the arm hub 104 may simply include a single hub plate configured to be coupled along either side of the first end 108 of each stiffening arm 102 so as to form a single-lap joint connection between the arm hub 104 and each stiffening arm 102.

It should be appreciated that the component(s) of the arm hub 104 may generally be configured to be coupled to the stiffening arms 102 using any suitable attachment means and/or method known in the art. For example, in one embodiment, the hub plate(s) 122, 124 may be welded or riveted to the second end 108 of each stiffening arm 102. Alternatively, as shown in the illustrated embodiment, the hub plate(s) 122, 124 may be configured to be coupled to the stiffening arms 102 using one or more suitable fasteners 126 (e.g., bolts, screws, threaded rods, etc.). For example, as particularly shown in FIG. 3, the hub plate(s) 122, 124, may define one or more hub openings 128 configured to be aligned with corresponding arm openings 130 defined in the second end 108 of each stiffening arm 102. As such, the fasteners 126 (only three of which being shown in FIG. 3) may be inserted through and secured within each pair/set of aligned openings 128, 130 (e.g., via a nut 120 and, optionally, a washer) in order to couple the stiffening arms 102 to the arm hub 104.

One of ordinary skill in the art should appreciate that the inner circumference of the root portion 32 (defined around its inner surface 52) may not be perfectly round. As such, it may be desirable to provide for some radial adjustment within the root stiffener 100 to accommodate any local out-of-roundness of the root portion 32. For example, as particularly shown in FIG. 3, in one embodiment, the arm openings 130 defined at the second end 108 of each stiffening arm 102 may be elongated in the radial direction. As such, the arm openings 130 may provide for adjustment of the relative radial positioning between the arm hub 104 and each stiffening arm 102 when installing the root stiffener 100 within the rotor blade 22. Of course, in other embodiments, the root stiffener 100 may have any other suitable configuration that provides for radial adjustment of its components relative to one another and/or relative to the inner surface 52 of the root portion 32.

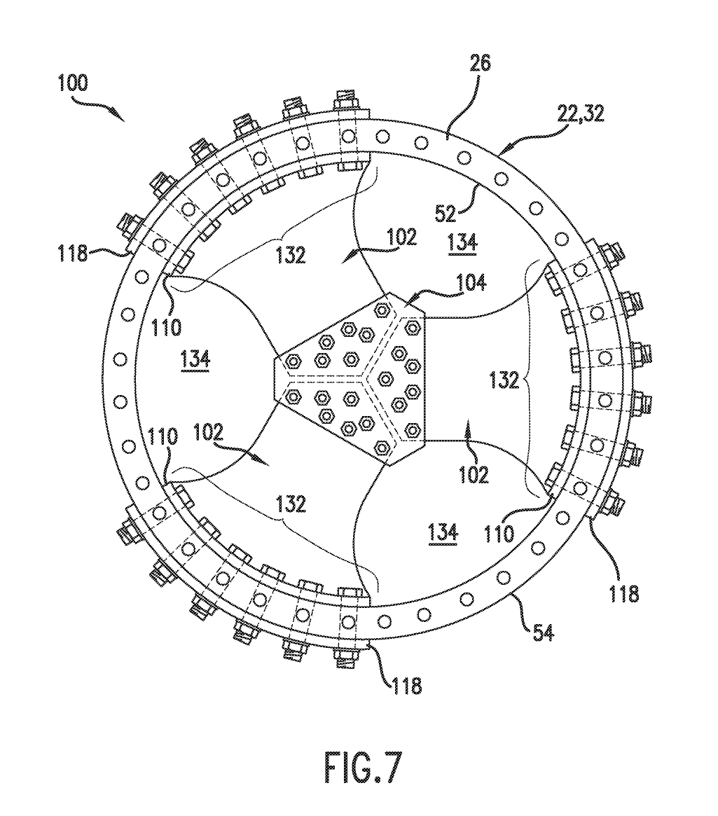

Additionally, in several embodiments, the disclosed root stiffener 100 may be configured to extend circumferentially around only a portion of the inner circumference of the root portion 32. For example, as particularly shown in FIG. 4, in one embodiment, the stiffening arms 102 (more particularly, the connection flange 110 of each stiffening arm 102) may only be configured to extend circumferentially around a small portion of the inner circumference of the root portion 32 (e.g., indicated by the bracketed circumferential segments 132). As such, rather large gaps or openings 134 may be defined directly between the inner surface 52 of the root portion 32 and each adjacent pair of stiffening arms 102. In another embodiment, as shown in FIG. 7, the stiffening arms 102 may be configured to flare outwardly as each arm 102 extends towards the inner surface 52 of the root portion 32. As such, the stiffening arms 102 may extend circumferentially around a larger portion of the inner circumference (e.g., indicated by the bracketed circumferential segments 132), thereby creating smaller gap or openings 134 between the inner surface 52 of the root portion 32 and each adjacent pair of stiffening arms 102.

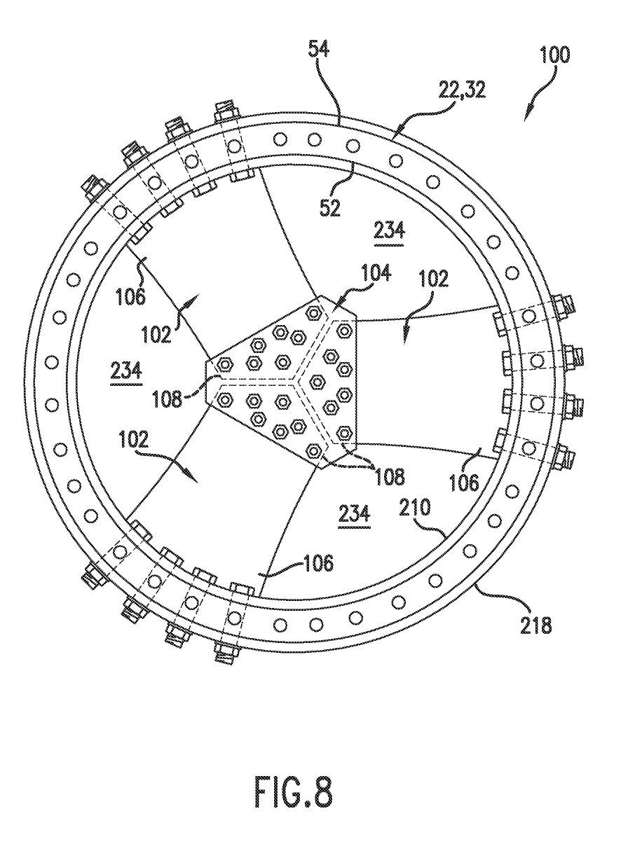

In alternative embodiments, one or more components of the root stiffener 100 may be configured to extend circumferentially around the entire inner circumference of the root portion 32. For example, in one embodiment, instead of including separate connection flanges 110 for coupling each stiffening arm 102 to the root portion 32, the root stiffener 100 may include a connection flange 210 that is configured to extend circumferentially around the entire inner circumference of the root portion 32. Specifically, as shown in FIG. 8, the connection flange 210 may be configured to form a stiffening ring around the inner circumference of the root portion 32, with the first end 106 of each stiffening arm 102 being formed integrally with or being separately attached to the connection flange 210 (e.g., via welding). In such an embodiment, gaps or openings 234 may be defined directly between the connection flange 210 and each pair of adjacent stiffening arms 102 instead of being defined directly between the inner surface 52 of the root portion 32 and each pair of adjacent stiffening arms 102.

Moreover, instead of including separate connection members 118 configured to extend around short circumferential segments of the outer circumference of the root portion 32, the root stiffener 100 may include a connection member 218 that is configured to extend circumferentially around the entire outer circumference of the root portion 32. Specifically, as shown in FIG. 8, the connection member 218 may be configured to form a stiffening ring around the outer circumference of the root portion 32.

It should be appreciated that, although the root stiffener 100 shown in FIG. 8 includes both a ring-shaped connection flange 210 and a ring-shaped connection member 218, the root stiffener 100 may include any combination of configurations for such components. For instance, in alternative embodiments, the root stiffener 100 may include separate connection flanges 110 (e.g., as shown in FIG. 4) together with a ring-shape connection member 218 (e.g., as shown in FIG. 8) or the root stiffener 100 may include a ring-shaped connection flange 210 (e.g., as shown in FIG. 8) together with separate connection members 118 (e.g., as shown in FIG. 4).

It should also be appreciated that the root stiffener 100 may generally be configured to be positioned at any suitable spanwise location within the root portion 32 of the rotor blade 22. For example, in the embodiment shown in FIG. 4, the root stiffener 100 is generally positioned at a location outboard of the root attachment assemblies 42 (e.g., at a location closer to the tip end 28 of the rotor blade 22 than the root attachment assemblies 42). Alternatively, all or a portion of the root stiffener 100 may be positioned at a location inboard of the root attachment assemblies 42 (e.g., at a location between the root end 26 and the barrel nuts 44) or at a location generally aligned with the root attachment assemblies 42.

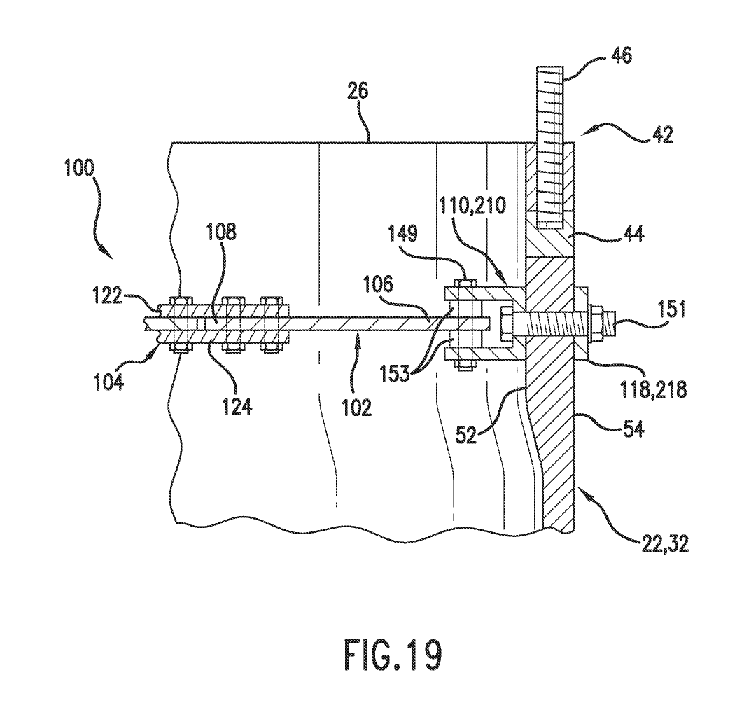

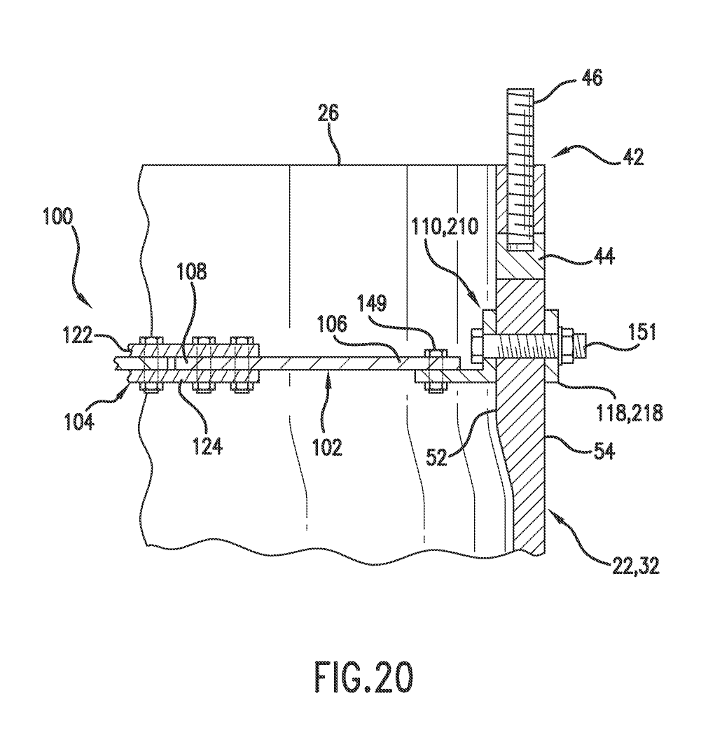

Further, it should also be appreciated that, as indicated above, the connection flange(s) 110, 210 of the root stiffener 100 may, in several embodiments, comprise a separate component(s) configured to be separately attached to the stiffener arms 102. For example, FIGS. 19 and 20 illustrate partial cross-sectional views of the root stiffener 100 shown in FIG. 5 having a connection flange(s) 110, 210 coupled to each stiffener arm 102. Specifically, as shown in FIG. 19, the connection flange(s) 110, 210 is configured as a “U” or “C” shaped flange(s) that is separately coupled to each stiffening arm 102 using one or more suitable fasteners 149 (and, optionally, one or more spacers 153). Additionally, the connection flange(s) 110, 210 may be coupled to the root portion 32 via one or more separate fasteners 151 extending through the connection flange(s) 110, 210 and into and/or through the root portion 32. For instance, as shown in FIG. 19, the fastener 151 may extend to the outer surface 54 of the root portion 32 and may be coupled to the root portion 32 via a suitable outer connection member 118, 218. Moreover, in the embodiment shown in FIG. 20, the connection flange(s) 110, 210 is configured as an “L” shaped flange(s) that is separately coupled to each stiffening arm 102 using one or more suitable fasteners 149. Similar to that shown in FIG. 19, the “L” shaped connection flange(s) 110, 210 may also be coupled to the root portion 32 via one or more fasteners 151. Alternatively, the connection flange(s) 110, 210 shown in FIGS. 19 and 20 may be configured to be coupled to each stiffening arm 102 and/or the root portion 32 using any other suitable means, such as by adhering the connection flange(s) 110, 210 to each stiffening arm 102 and/or the root portion 32 using suitable adhesives.

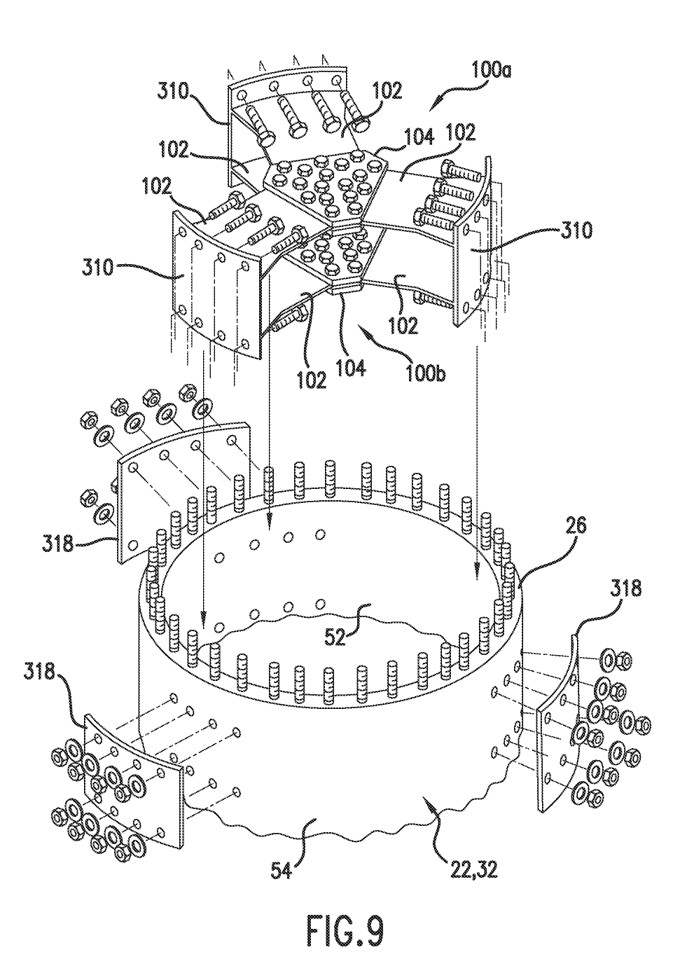

Additionally, it should be appreciated that any number of root stiffeners 100 may be installed within the root portion 32 of the rotor blade 22. For example, as shown in FIG. 9, the rotor blade 22 includes both a first root stiffener 100a and a second root stiffener 100b installed within the root portion 32. In such an embodiment, the first and second root stiffeners 100a, 100b may generally be configured the same as or similar to the root stiffener 100 described above. For instance, the root stiffeners 100a, 100b may be configured as completely separate installations, with each including its own separate components. In another embodiment, as shown in FIG. 9, as an alternative to each root stiffener 100a, 10 including its own connection flange(s) 110, 210 and/or connection member(s) 118, 218, the root stiffeners 100a, 100b may share a common connection flange(s) 310 and/or a common connection member(s) 318. For instance, in the illustrated embodiment, the common connection flange(s) 318 and connection member(s) 318 are configured similar to the separate connection flanges 110 and connection members 118 shown in FIG. 4. Alternatively, the common connection flange(s) 318 and connection member(s) 318 may be configured similar to the ring-shaped connection flanges 210 and connection members 218 shown in FIG. 8.

Moreover, it should also be appreciated that the disclosed root stiffener 100 may generally be configured to have any suitable number of stiffening arms 102. Specifically, in the illustrated embodiment, the root stiffener 100 includes three stiffening arms 102. In such an embodiment, the configuration of both the arm hub 104 and the stiffening arms 102 may be specifically adapted to accommodate coupling three stiffening arms 102 to the arm hub 104 (e.g., by configuring the second end 108 of each stiffening arm 102 to define a 120 degree wedge shape). However, in other embodiments, the root stiffener 100 may only include two stiffening arms 102 or more than three stiffening arms 102, such as four, five or more stiffening arms 102, with the arm hub 104 and the stiffening arms 102 being appropriately configured in each embodiment to accommodate the given number of stiffening arms 102. For instance, in an embodiment in which the root stiffener 100 includes four stiffening arms 102, the second end 108 of each stiffening arm 102 may be configured to define a 90 degree wedge shape or may define any other suitable shape that permits each stiffening arm 102 to be coupled to and extend outwardly from the arm hub 104.

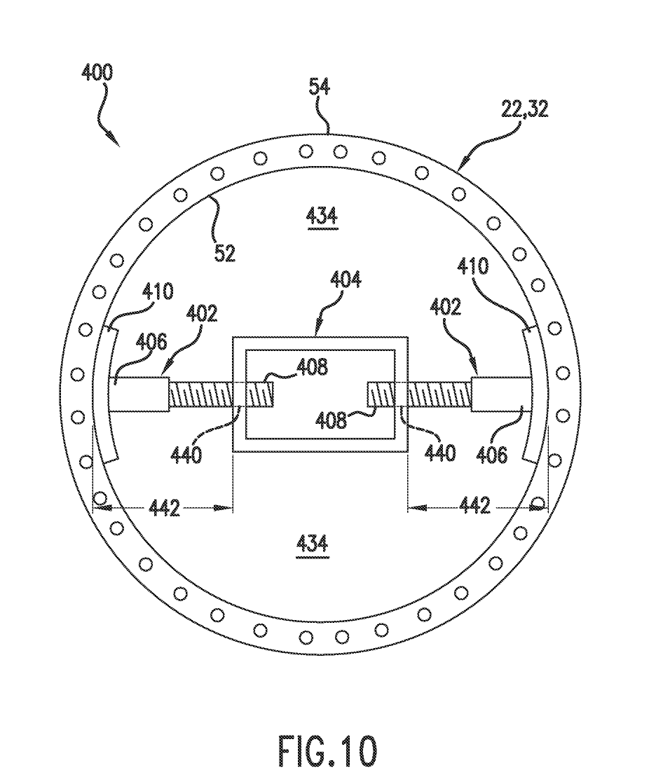

Referring now to FIG. 10, a top, assembled view of another embodiment of a root stiffener 400 is illustrated in accordance with aspects of the present subject matter. Similar to the root stiffener 100 described above, the root stiffener 400 may be configured to be installed within the root portion 32 of the rotor blade 22 and may include a plurality of stiffening arms 402 extending radially outwardly from an arm hub 404 towards the inner surface 52 of the root portion 32. For example, as shown in FIG. 10, each stiffening arm 402 may extend radially between a first end 406 and a second end 406, with the first end 406 being configured to be coupled to and/or in contact with the root portion 32 and the second end 408 being configured to be coupled to the arm hub 404. Additionally, similar to the root stiffener 100 described above, the root stiffener 400 may, in one embodiment, only be configured to extend circumferentially around a portion of the inner circumference of the root portion 32, thereby creating gaps or openings 434 defined directly between the inner surface 52 of the root portion 32 and each adjacent pair of stiffening arms 402.

However, unlike the embodiments described above, the arm hub 404 may be configured as a turnbuckle or other similar rotatable component and, thus, may be configured to be rotatably coupled to the stiffening arms 402. For example, in several embodiments, the arm hub 404 may define a plurality of threaded openings 440, with each opening 440 being configured to receive a threaded, second end 408 of each arm 402. In such an embodiment, the arm hub 404 and/or the stiffening arms 402 may be rotated relative to one another to adjust a radial distance 442 defined between the arm hub 402 and the first end 406 of each stiffening arm 402. Thus, when installing the root stiffener 400 within the rotor blade 22, the radial distance(s) 442 may be adjusted to ensure that the first end 406 of each stiffening arm 402 contacts and/or is positioned against the inner surface 52 of the root portion 32.

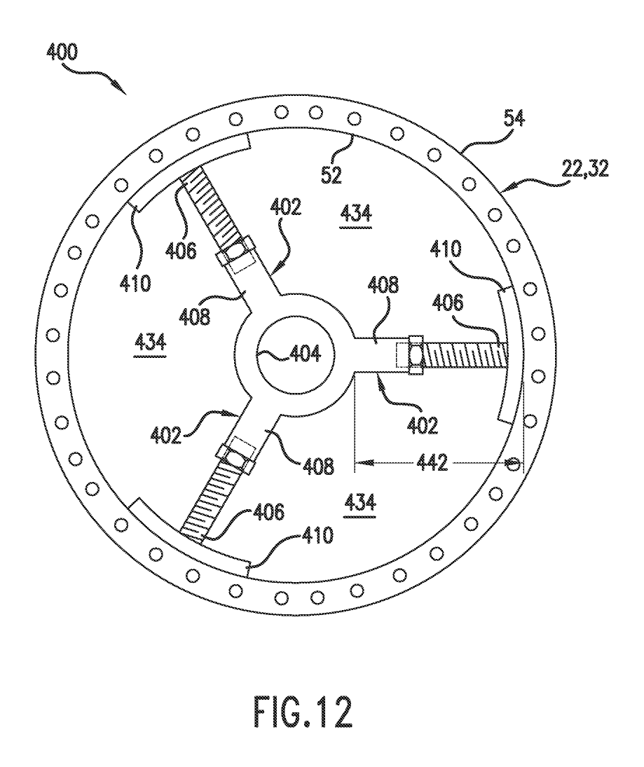

It should be appreciated that, although the arm hub 404 is shown in FIG. 10 as having a rectangular shape, the arm hub 404 may generally be configured to define any suitable shape and/or may have any other suitable configuration that permits it to function as described herein. For instance, in an alternative embodiment, the arm hub 404 may define a circular shape (e.g., similar to that shown in FIG. 12).

It should also be appreciated that, as an alternative to a threaded connection, the second end 408 of each stiffening arm 402 may be configured to be coupled to the arm hub 404 using any other suitable connection that allows for relative movement between such components. For instance, instead of being rotatably coupled to the arm hub, the stiffening arms 402 may be configured to be slidably received within corresponding openings 440 defined in the arm hub 404. In such an embodiment, a suitable locking mechanism (e.g., a pin) may be utilized to lock each stiffening arm 402 in place relative to the arm hub 404 once the root stiffener 400 has been properly installed within the rotor blade 22.

Additionally, as shown in FIG. 10, a connection flange 410 may be disposed at the first end 406 of each stiffening arm 402. However, unlike the connection flange(s) 110, 210, 310 described above, the connection flanges 410 may simply be configured to frictionally engage the inner surface 52 of the root portion 32. For example, by adjusting the radial distance 242 defined between the arm hub and the first end 406 of each stiffening arm 402, the connection flanges 401 may be moved outwardly so as to engage the inner surface 52 of the root portion 32, thereby securing the root stiffener 400 within the rotor blade 22. In such an embodiment, a suitable friction coating (e.g., a tungsten carbide or a titanium carbide coating) may be applied to the outer surface of each connection flange 410 to provide an enhanced frictional interface between the stiffening arms 402 and the inner surface 52 of the root portion 32.

Alternatively, the connection flanges 410 may be configured to be secured to the root portion 32 using any other suitable means. For instance, after adjusting the radial distance(s) 242 to ensure that each connection flange 410 is contacting the inner surface 52, suitable fasteners may be utilized to secure each connection flange 410 to the root portion 32 (e.g., similar to that shown in FIG. 4). In such an embodiment, as described above, a connection member(s) (not shown) may also be disposed along the outer surface 54 of the root portion 32 to facilitate securing the stiffening arms 402 to the root portion 32.

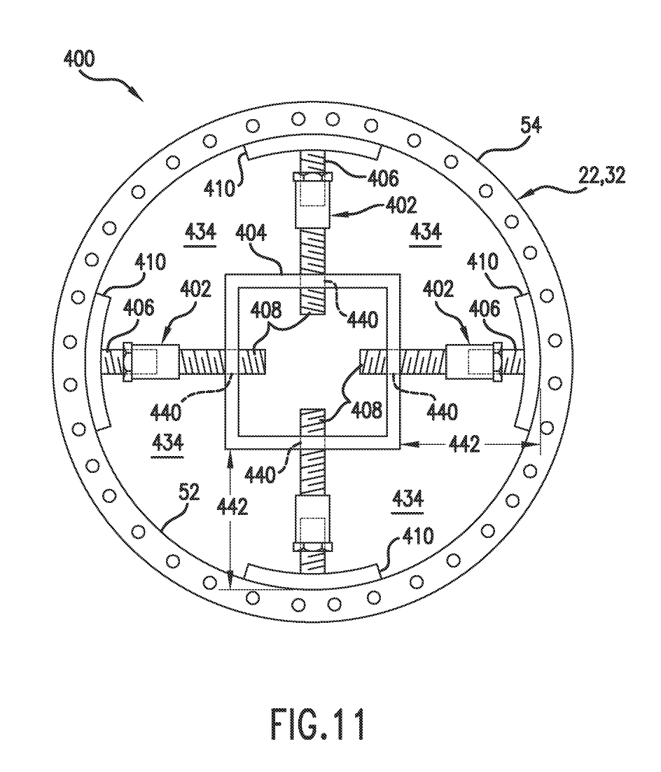

It should be appreciated that, in embodiments in which it is desired for the root stiffener 400 to include more than two stiffening arms 402, the arm hub 404 need not be configured as a turnbuckle, but, rather, may simply be configured as a non-rotatable component of the root stiffener 400. For example, as shown in FIG. 11, the root stiffener 400 includes four stiffening arm 402 coupled to and extending outwardly from the arm hub 404. In such an embodiment, instead of having the capability of rotating the arm hub 402 relative to stiffening arms 404 (as may be done in the embodiment shown in FIG. 10), the radial distance 442 may be adjusted by individually rotating each stiffening arm 402 relative to the arm hub 404. Additionally, in several embodiments, the radial distance 442 may also be adjusted by independently adjusting the position of the first end 406 of each stiffening arm 402 relative to the arm hub 404. For example, as shown in FIG. 11, each connection flange 410 may be coupled to remainder of its corresponding stiffening arm 402 via a threaded connection, thereby allowing the radial distance 442 to be adjusted by independently rotating each connection flange 410.

In other embodiments, instead of providing adjustability at both ends 406, 408 of the stiffening arms 402, such radial adjustment may only be provided at the first end 406 of each stiffening arm 402. For example, FIG. 12 illustrates an embodiment in which the second end 408 of each stiffening arm 402 is formed integrally with or is otherwise fixed in position relative to the arm hub 404 (e.g., by rigidly coupling each stiffening arm 402 to the arm hub 404). In such an embodiment, the radial distance 442 may be varied by adjusting the position of each connection flange 410 relative to the remainder of its corresponding stiffening arm 402. For instance, similar to the embodiment described above with reference to FIG. 11, a threaded connection may be used to couple the connection flanges 410 to the stiffening arms 402, thereby allowing the connection flanges 410 to be moved radially outwardly (or inwardly) independent of the remainder of the stiffening arms 402.

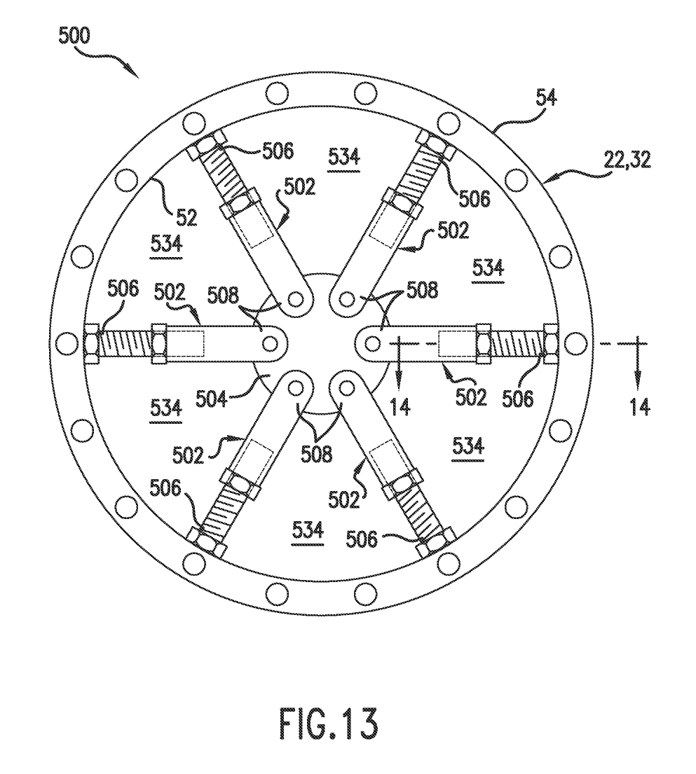

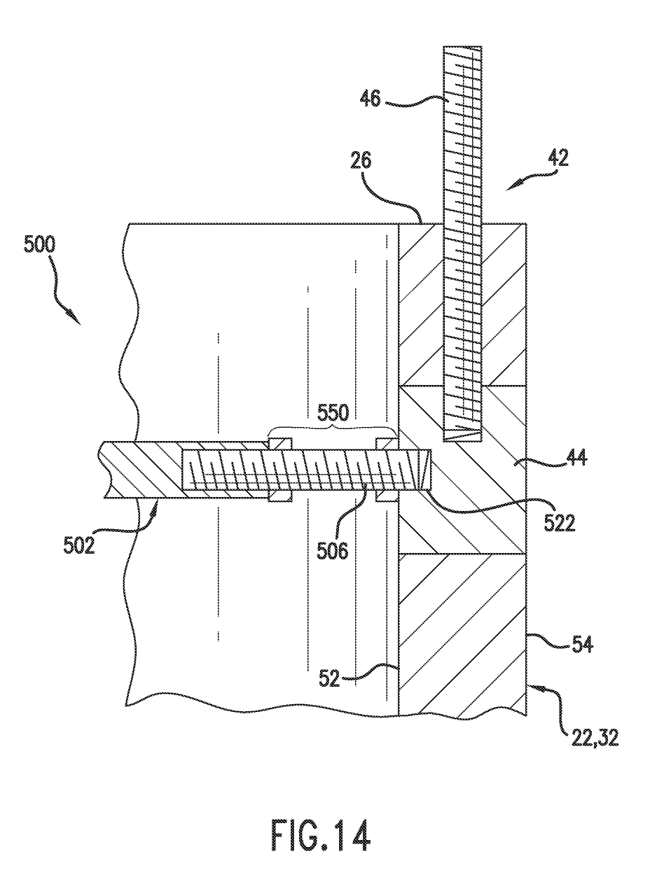

Referring now to FIGS. 13 and 14, yet another embodiment of a root stiffener 500 is illustrated in accordance with aspects of the present subject matter. Specifically, FIG. 13 illustrates a top, assembled view of the root stiffener 500 and FIG. 14 illustrates a partial, cross-sectional view of the root stiffener 500 shown in FIG. 13 taken about line 14-14.

Similar to the root stiffener 100 described above, the root stiffener 500 may be configured to be installed within the root portion 32 of the rotor blade 22 and may include a plurality of arms 502 extending radially outwardly from an arm hub 504 towards the inner surface 52 of the root portion 32. For example, as shown in FIG. 13, each arm 502 may extend radially between a first end 506 and a second end 508, with the first end 506 being configured to be coupled to the root portion 32 and the second end 508 being configured to be coupled to the arm hub 504. Additionally, the root stiffener 500 may, in one embodiment, only be configured to extend circumferentially around a portion of the inner circumference of the root portion 32, thereby creating gaps or openings 534 defined directly between the inner surface 52 of the root portion 32 and each adjacent pair of stiffening arms 502.

As shown in FIG. 13, in several embodiments, the stiffening arms 502 may be configured as tie rods, cables and/or any other suitable components that may be tensioned or tightened within root portion 32 using a suitable tensioning/adjustment means. For example, a turnbuckle 550 (FIG. 14) or another similar component may be integrated or incorporated into each stiffening arm 502. As such, after coupling the first and second ends 506, 508 of each stiffening arm 502 to the root portion 32 and arm hub 504, respectively, the turnbuckle 550 (or other suitable component) may be manipulated to tighten/tension each stiffening arm 502.

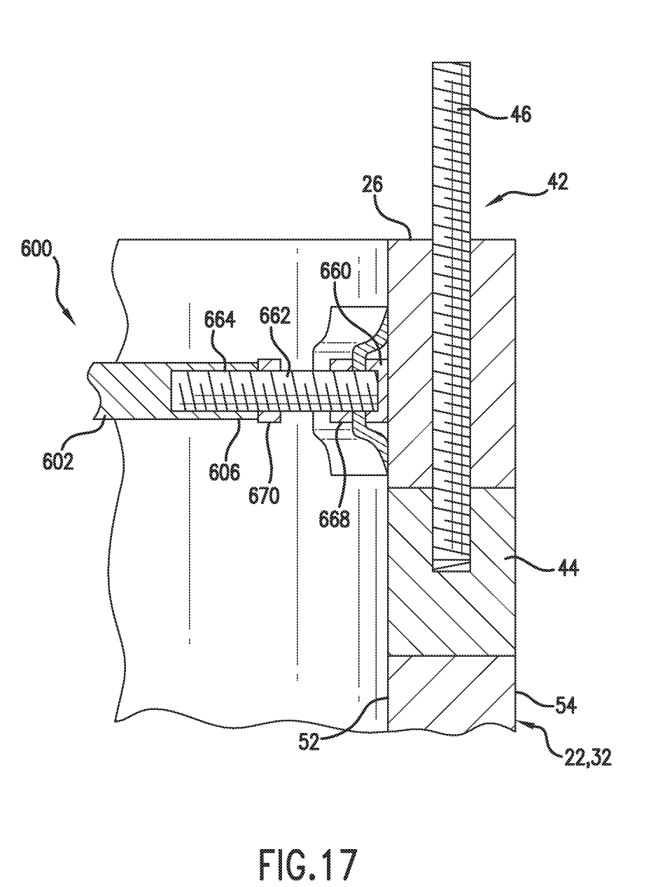

It should be appreciated that, in the illustrated embodiment, the stiffening arms 502 may be configured to be coupled to the root portion 32 using any suitable attachment means and/or method known in the art. For example, in one embodiment, the stiffening arms 502 may be coupled to the root portion 32 via suitable fasteners (not shown) extending from the stiffening arms 502 entirely through the root portion 32, similar to the embodiment shown in FIG. 4. Alternatively, each stiffening arm 504 may be coupled to a suitable insert (e.g., a threaded insert) coupled to and/or installed within the root portion 32. For example, as particularly shown in FIG. 14, in one embodiment, a radially extending, threaded opening 552 may be tapped through the side of the barrel nut 44 located adjacent to the second end 508 of each stiffening arm 502. In such an embodiment, the second end 508 of each stiffening arm 502 (or a separate component coupled to the second end 508) may be coupled to each associated barrel nut 44 to secure the stiffening arms 502 to the root portion 32. In a further embodiment, a separate threaded insert (e.g., the threaded insert 660 described below with reference to FIG. 17) may be coupled to and/or installed within the root portion 32 and utilized to secure each stiffening arm 502 to the root portion 32.

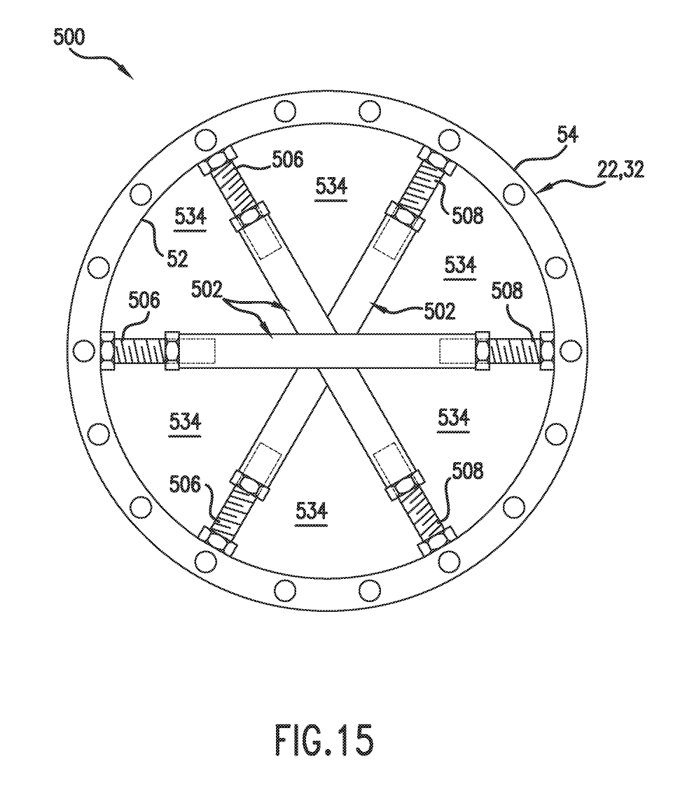

It should also be appreciated that, as an alternative to the embodiment shown in FIGS. 13 and 14, the root stiffener 500 may simply include a plurality of stiffening arms 502 coupled between separate locations along the inner surface 52 of the root portion 32 without the necessity of including the disclosed arm hub 504. For example, as shown in FIG. 15, stiffening arms 502 (e.g., configured as tie rods, cables, rigid structural members and/or the like) may be configured to extend across the interior of the root portion 32 in any suitable direction and/or pattern, with the ends 506, 508 of each stiffening arm 502 being coupled to the root portion 32 using any suitable attachment means and/or method known in the art (e.g., by securing the ends 506, 508 to the barrel nuts 44 in a manner similar to that shown in FIGS. 13 and 14).

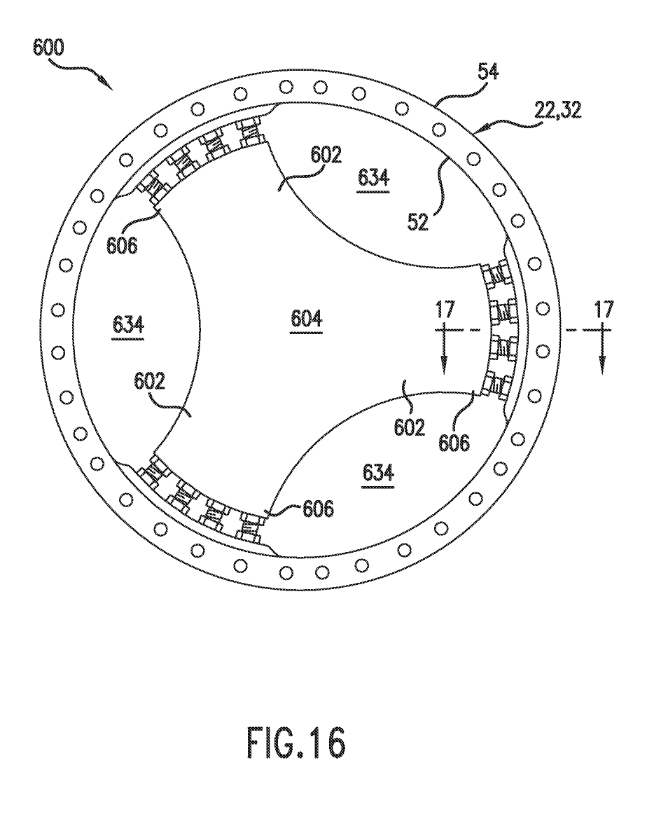

Referring now to FIGS. 16 and 17, yet another embodiment of a root stiffener 600 is illustrated in accordance with aspects of the present subject matter. Specifically, FIG. 16 illustrated a top, assembled view of the root stiffener 600 and FIG. 17 illustrates a partial, cross-sectional view of the root stiffener 600 shown in FIG. 16 taken about line 17-17.

Similar to the root stiffener 100 described above, the root stiffener 600 may be configured to be installed within the root portion 32 of the rotor blade 22 and may include a plurality of stiffening arms 602 extending radially therein. Additionally, the root stiffener 600 may, in one embodiment, only be configured to extend circumferentially around a portion of the inner circumference of the root portion 32, thereby creating gaps or openings 634 defined directly between the inner surface 52 of the root portion 32 and each adjacent pair of stiffening arms 602.

However, unlike many of the embodiments described above, the stiffening arms 602 may not be coupled to and/or extend from a separate arm hub. Rather, as shown in the illustrated embodiment, the root stiffener 600 may be configured as a single component and may include a central hub portion 604 formed integrally with the stiffening arms 602. Thus, in such an embodiment, each stiffening arm 602 may extend radially outwardly from the central hub portion 604 to a first end 606 configured to be coupled to and/or disposed adjacent to the root portion 32. As particularly shown in FIG. 16, the root stiffener 600 includes three stiffening arms 602. However, in other embodiments, the root stiffener 600 may include any other number of stiffening arms 602 extending outwardly from the hub portion 604 towards the inner surface 52 of the root portion 32, such as two stiffening arms 602 or greater than three stiffening arms 602 (e.g., four, five or more stiffening arms 602).

It should be appreciated that the first end 606 of each stiffening arm 602 may be configured to be coupled to the root portion 32 using any suitable attachment means and/or method known in the art. For example, in several embodiments, one or more threaded inserts 660 may be coupled to and/or installed within the root portion 32 for receiving a suitable fastener 662 (e.g., a bolt, screw, threaded rod, etc.) configured to extend outwardly from and/or be received within one or more corresponding threaded openings 664 defined in each stiffening arm 602. Specifically, as shown in FIG. 17, in one embodiment, each threaded insert 660 may be coupled to the inner surface 52 of the root portion 32 (e.g., by applying an over laminate across each threaded insert 660 or by using a suitable adhesive). Alternatively, the threaded insert 660 may be configured to be at least partially installed and/or received within the root portion 32 (e.g., by forming suitable openings within the root portion 32 to receive each threaded insert). In either embodiment, to secure the root stiffener 600 within the root portion 32, each fastener 662 may be threaded between one of the threaded openings 664 defined in each stiffening arm 602 and a corresponding threaded insert 660 positioned on and/or within the root portion 32.

Additionally, to allow for radial adjustment of the root stiffener 600, a turnbuckle or any other similar component may be associated with each fastener 662. For example, as shown in FIG. 17, a first nut 668 may be secured against the threaded insert 660 to lock the fastener 662 in place while a second nut 670 may be threaded against the corresponding stiffening arm 602 to allow for radial adjustment of the root stiffener 600.

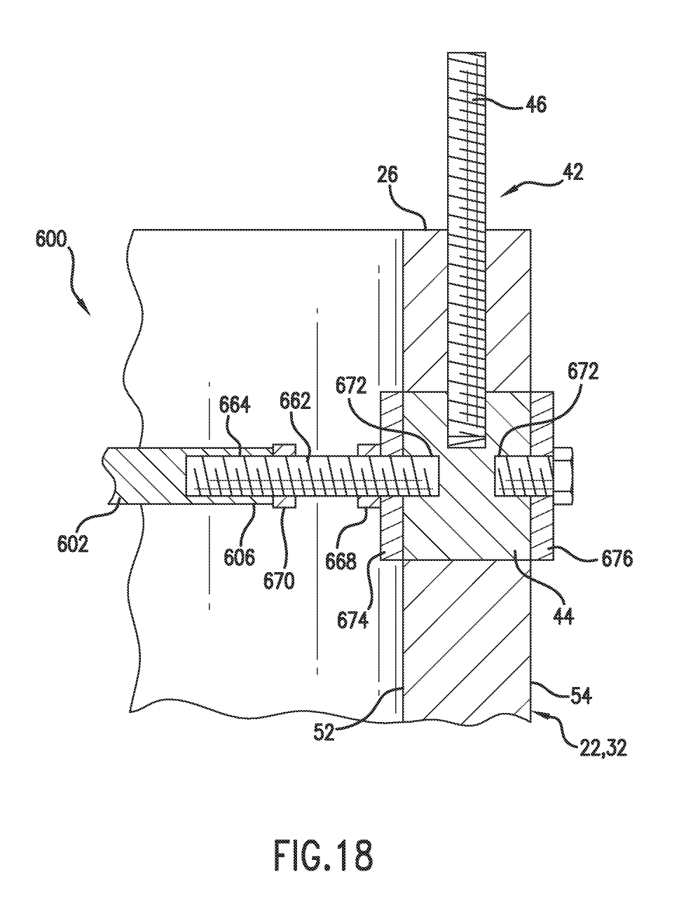

As indicated above, as an alternative to utilizing a separate threaded insert 660 to secure the root stiffener 600 within the rotor blade 22, one or more of the barrel nuts 44 may be utilized as the disclosed threaded inserts. For example, as shown in FIG. 18, a threaded opening 672 may be defined in the side of each associated barrel nut 44 that is configured to receive the fastener 662 extending from the threaded openings 664 defined in each stiffening arm 602. Additionally, a turnbuckle-style configuration similar to that described above with reference to FIG. 17 may be utilized to allow for radial adjustment of the root stiffener 600.

Moreover, as shown in FIG. 18, inner and outer clamp plates 674, 676 may also be installed along the inner and outer surfaces 52, 54, respectively, of the root portion 32 adjacent to either side of the associated barrel nuts 44. Such clamp plates 674, 676 may be configured similarly to the connection flange(s) 110, 210 and member(s) 118, 218 described above. For example, in one embodiment, the inner and/or outer clamp plates 674, 676 may be configured as arced or curved segments extending along only a portion of the inner and outer circumference, respectively, of the root portion 32 (similar to the connection flanges 110 and members 118 shown in FIG. 4). Alternatively, the inner and/or outer clamp plates 674, 676 may be configured as 360 degree rings extending around the entire inner and outer circumference, respectively, of the root portion 32 (similar to the connection flange 210 and member 218 shown in FIG. 7). It should be appreciated that the illustrated clamp plates 674, 676 may also be utilized in other embodiments in which the disclosed stiffening arms are being coupled to the barrel nuts 44, such as in the embodiment shown in FIGS. 13 and 14.

In general, both the stiffening arms and the arm hub (or hub portion) of the root stiffeners disclosed herein have been illustrated and described as being disposed entirely within the root portion 32 of the rotor blade 22. Specifically, in the illustrated embodiments, the stiffening arms and arm hub (or hub portion) are contained both circumferentially (i.e., by being disposed within the cylindrical plane define by the inner circumference of the root portion 32) and longitudinally (i.e., by being disposed outboard of the root end 26 of the rotor blade) within the root portion. However, in other embodiments, portions of the stiffening arms and/or arm hub (or hub portion) may extend circumferentially or longitudinally outside the volume defined within the root portion 32. For instance, in one embodiment, the root stiffeners may be installed at a position adjacent to the root end 26 of the rotor blade 22 such that at least a portion of the stiffening arms and/or the arm hub (or hub portion) extends longitudinally outside the root portion 32 (i.e., by extending longitudinally across the plane defined at the root end 26). In another embodiment, the stiffening arms may extend from the inner surface 52 of the root portion 32 at an angle such that at least a portion of the stiffening arms and/or the arm hub (or hub portion) extends longitudinally beyond the root end 26 of the rotor blade 22.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A rotor blade for a wind turbine, the rotor blade comprising:
a body extending between a root end and a tip end, the body including a root portion extending from the root end, the root portion including an inner surface defining an inner circumference;
a root stiffener disposed at least partially within the root portion of the body, the root stiffener including a plurality of arms extending radially from the inner surface,
wherein the root stiffener is configured to extend circumferentially around only a portion of the inner circumference of the root portion.

2. The rotor blade of claim 1, wherein the root stiffener further comprises a separate arm hub coupled to the plurality of arms, each arm extending radially from the arm hub towards the inner surface of the root portion.

3. The rotor blade of claim 2, wherein each arm extends radially between a first end and a second end, the first end configured to be coupled to the root portion and the second end configured to be coupled to the arm hub.

4. The rotor blade of claim 3, wherein the second end of each arm is fixed in position relative to the arm hub.

5. The rotor blade of claim 3, wherein the arm hub comprises at least one hub plate defining a plurality of hub openings, the second end of each arm defining an arm opening configured to be aligned with one of the plurality of hub openings.

6. The rotor blade of claim 3, wherein the second end of each arm is configured to be moved relative to the arm hub so as to adjust a radial distance defined between the arm hub and the first end of each arm.

7. The rotor blade of claim 3, further comprising a connection flange disposed at the second end of at least one of the arms, the connection flange configured to extend adjacent to the inner surface of the root portion.

8. The rotor blade of claim 7, wherein the connection flange is configured to be moved relative to the second end of the at least one of the arms.

9. The rotor blade of claim 7, wherein the connection flange is either configured to extend around only a portion of the inner circumference or the connection flange is configured to extend around the entire inner circumference.

10. The rotor blade of claim 7, further comprising a connection member disposed along an outer surface of the root portion, the connection member being configured to be coupled to the connection flange using at least one fastener extending through the root portion.

11. The rotor blade of claim 10, wherein the outer surface defines an outer circumference of the root portion, the connection flange being configured to extend around only a portion of the outer circumference or the connection flange being configured to extend around the entire outer circumference.

12. The rotor blade of claim 1, wherein the root stiffener further comprises a hub portion formed integrally with the plurality of arms, each arm extending radially from the hub portion towards the inner surface of the root portion.

13. The rotor blade of claim 1, further comprising a plurality of threaded inserts associated with the root portion, each arm being coupled to the root portion via at least one of the threaded inserts.

14. A rotor blade for a wind turbine, the rotor blade comprising:
a body extending between a root end and a tip end, the body including a root portion extending from the root end, the root portion including an inner surface;
a root stiffener disposed at least partially within within the root portion of the body, the root stiffener including a separate arm hub and a plurality of arms coupled to the arm hub, each arm extending radially outwardly from the arm hub towards the inner surface of the root portion.

15. The rotor blade of claim 14, wherein each arm extends radially between a first end and a second end, the first end configured to be coupled to the root portion and the second end configured to be coupled to the arm hub.

16. The rotor blade of claim 15, wherein the second end of each arm is fixed in position relative to the arm hub.

17. The rotor blade of claim 15, wherein the arm hub comprises at least one hub plate defining a plurality of hub openings, the second end of each arm defining an arm opening configured to be aligned with one of the plurality of hub openings.

18. The rotor blade of claim 15, wherein the second end of each arm is configured to be moved relative to the arm hub so as to adjust a radial distance defined between the arm hub and the first end of each arm.

19. The rotor blade of claim 15, further comprising a connection flange disposed at the second end of at least one of the arms, the connection flange configured to extend adjacent to the inner surface of the root portion.

20. The rotor blade of claim 19, wherein the connection flange is configured to be moved relative to the second end of the at least one of the arms.

21. The rotor blade of claim 19, wherein the connection flange is either configured to extend around only a portion of the inner circumference or the connection flange is configured to extend around the entire inner circumference.

22. The rotor blade of claim 19, further comprising a connection member disposed along an outer surface of the root portion, the connection member being configured to be coupled to the connection flange using at least one fastener extending through the root portion.

23. The rotor blade of claim 22, wherein the outer surface defines an outer circumference of the root portion, the connection flange being configured to extend around only a portion of the outer circumference or the connection flange being configured to extend around the entire outer circumference.
